(19) United States
(12) Patent Application Publication
(10) Pub. No.: US 2006/0076446 A1
(43) Pub. Date: Apr. 13, 2006

(54) Tape cartridge

(75) Inventor: Teruo Sogabe, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 11/245,108

(22) Filed: Oct. 7, 2005

(30) Foreign Application Priority Data
Oct. 12, 2004 (JP) 2004-297824

(51) Int. Cl. G11B 23/107

(52) U.S. Cl. 242/348

(57) ABSTRACT

A tape cartridge in which adverse influences on windability attributed to at least one cause selected from entrapment of entrained air, vibration of tapes and flipping of tapes are suppressed is provided. The tape cartridge is composed of a case, a reel disposed inside the case, a band-like tape which can be wound onto the reel in a feedable way, a pressing member (e.g., touch roller) for pressing an unwound portion of the tape to a tape roll including a wound portion of the tape and the reel at a contact start point between the unwound portion and the tape roll during winding of the tape, and a position adjustment member for adjusting a position of the pressing member in conformity to changes in diameter of the tape roll while supporting the pressing member inside the case.

### BACKGROUND OF THE INVENTION

The present invention relates to a tape cartridge.

Conventional tape cartridges include those structured, in order to improve windability of tapes, to have a through hole or a recess groove on a flange of a reel, onto which a tape is wound, so as to release air (hereinbelow also referred to as “entrained air”) brought together with the tape during winding of the tape (see, e.g., JP 2001-118355 A).

However, in conventional cartridges, the running positions of tapes were not stabilized due to habits of tapes themselves such as uneven thickness and curvature of the tapes, and this caused disturbed winding. Consequently, the through hole and the recess groove, which effectively release entrained air by close contact between the tape and the flange, could not fully perform its function.

Further, even if the windability should be secured in the manufacturing stage (before shipment), there still existed a problem that the windability was lost depending on the accuracy of running systems of drives when users run the tapes in the drives. Moreover, there was a problem that the windability was damaged by vibration of tapes during their running (vibration in width direction of the tapes), flipping of the tapes (vibration in thickness direction of the tapes) and the like.

### SUMMARY OF THE INVENTION

An object of the present invention is to provide a tape cartridge in which adverse influences on windability attributed to at least one cause selected from entrapment of entrained air, vibration of tapes and flipping of tapes are suppressed.

A tape cartridge of the present invention includes: a case; a reel disposed inside the case; a band-like tape which can be wound onto the reel in a feedable way; a pressing member disposed inside the case for pressing an unwound portion of the tape to a tape roll at a contact start point between the unwound portion and the wound body during winding of the tape, the tape roll being composed of a wound portion of the tape which is wound onto the reel and the reel; and a position adjustment member for adjusting a position of the pressing member in conformity to changes in diameter of the tape roll while supporting the pressing member.

It is to be noted that the “contact start point” refers to a location (start point) at which an unwound portion of the tape starts to come into contact with the tape roll.

The present invention has the pressing member for pressing an unwound portion of the tape to the tape roll at a contact start point and has the position adjustment member for adjusting the position of the pressing member in conformity to changes in diameter of the tape roll. Consequently, at the moment of winding the unwound portion of the tape onto the tape roll, the tape (unwound portion) is pressed to the tape roll by the pressing member so that entrained air during winding of the tape can be released. Moreover, vibration and flipping of the tape can be suppressed. As a result, in the present invention, it becomes possible to provide a tape cartridge in which adverse influences on windability attributed to at least one cause selected from entrapment of entrained air, vibration of tapes (unwound portions) and flipping of tapes are suppressed.

### BRIEF DESCRIPTION OF THE DRAWINGS

The present invention will be further described with reference to the accompanying drawings wherein like reference numerals refer to like parts in the several views, and wherein:

FIG. 1 is a schematic view showing an inner structure of a tape cartridge in one example of the present invention;

FIGS. 2A to 2C are schematic views showing a touch roller and a position adjustment member constituting the tape cartridge shown in FIG. 1;

FIG. 3A is a schematic view showing an inner structure of a tape cartridge in another example of the present invention, while FIG. 3B is a schematic view showing a shaft pin and a rotation rod constituting the tape cartridge shown in FIG. 3A;

FIG. 4A is a schematic view showing an inner structure of a tape cartridge in still another example of the present invention, while FIG. 4B is a side view showing a structure composed of a touch roller, a guide roller and a plate;

FIG. 5 is a schematic view showing an inner structure of a tape cartridge in yet another example of the present invention;

FIG. 6 is a schematic view showing an inner structure of a tape cartridge in yet another example of the present invention;

FIG. 7A is a schematic view showing an inner structure of a tape cartridge in yet another example of the present invention, FIG. 7B is a plane view showing a structure composed of a sheet-like material, a guide roller and a plate, and FIG. 7C is a plane view showing the structure in another form;

FIG. 8 is a schematic view showing an inner structure of a tape cartridge in yet another example of the present invention in the state of being not loaded into a drive;

FIG. 9A is a cross sectional view taken along line I-I in FIG. 8, while FIG. 9B is an enlarged view of a section D in FIG. 9A;

FIG. 10 is a schematic view showing the inner structure of the tape cartridge shown in FIG. 8 immediately after being loaded into the drive;

FIG. 11A is a cross sectional view taken along line II-II in FIG. 10, while FIG. 11B is an enlarged view of a section E in FIG. 11A;

FIG. 12 is a cross sectional view taken along line III-III in FIG. 8;

FIG. 13A is a cross sectional view showing a tape cartridge in another example of the present invention in the state of being not loaded into the drive; while FIG. 13B is an enlarged view of a section F in FIG. 13A;

FIG. 14A is a cross sectional view showing a tape cartridge in still another example of the present invention immediately after being loaded into the drive, while FIG. 14B is an enlarged view of a section G in FIG. 14A; and

FIG. 15 is a perspective view showing a cylindrical article constituting the tape cartridge shown in FIG. 13 as viewed from the side of a through hole.

### DETAILED DESCRIPTION OF THE PREFERRED EMBODIMENTS

### First Embodiment

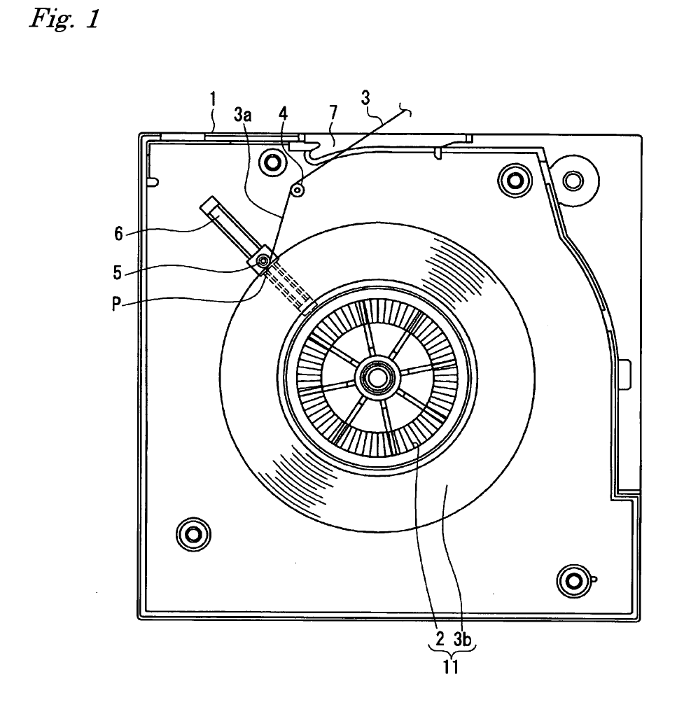

FIG. 1 is a schematic view showing an inner structure of a tape cartridge in the present embodiment. The tape cartridge shown in FIG. 1 is a single reel tape cartridge for use in data backup for computers.

As shown in FIG. 1, the tape cartridge in the present embodiment is composed of a case 1, a reel 2 disposed inside the case 1, a band-like tape 3 which can be wound onto the reel 2 in a feedable way, a rubber touch roller 5 serving as a pressing member, and a position adjustment member 6 for adjusting a position of the touch roller 5. The case 1 has an aperture 7 formed for pulling the tape 3 out of the case 1. Moreover, the case 1 has a door (unshown) for opening and closing the aperture 7.

The reel 2 can be engaged with a drive gear (unshown) of a drive unit. The drive gear rotating in the state of being engaged with the reel 2 rotates the reel 2. Rotation of the reel 2 winds the tape 3 onto the reel 2 or unwinds the tape 3 from the reel 2. A metallic leading article (unshown) is fixed to a leading end of the tape, and when the tape cartridge is loaded into the drive unit, the leading article is captured by a coupler of the drive unit.

The touch roller 5 acts so as to press a running tape 3a (unwound portion) to a tape roll 11 at a contact start point P between the tape 3a and the tape roll 11. It is to be noted that the tape roll 11 herein refers to a tape 3b (wound portion) wound around the reel 2.

The touch roller 5 has a bearing the like for achieving smooth rotation. Accordingly, at the moment when the tape 3a comes into contact with the tape roll 11, the touch roller 5 rotates and presses the tape 3a to the tape roll 11. The position adjustment member 6 has a function to adjust the position of the touch roller 5 in conformity with changes in diameter of the tape roll 11.

It is to be noted that in the state that the tape is not at all wound onto the reel 2, the touch roller 5 is in contact with the reel 2.

The tape cartridge in the present invention has a guide roller 4 disposed closer to the aperture 7 than the touch roller 5 (pressing member) for regulating the running position of the tape 3a. In the example shown in FIG. 1, the guide roller 4 is directly fixed onto the case 1 in a rotatable manner. The tape 3a goes into the case 1 along the guide roller 4.

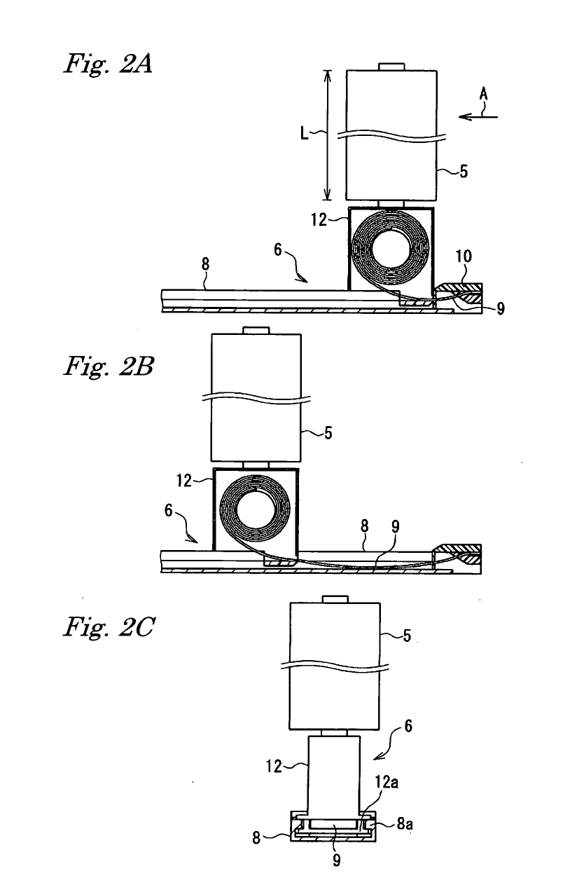

Movement of the touch roller 5 in conformity with changes in diameter of the tape roll 11 may be implemented by a position regulation member as shown in FIGS. 2A to 2C for example.

As shown in FIGS. 2A to 2C, the position adjustment member 6 has a constant-load spring 9 serving as a spring-type elastic body for biasing the touch roller 5 (pressing member) to the tape roll side, and a guide rail 8 supported by the case for allowing the touch roller 5 to slide. A spring stopper 10 gripping one end portion of the constant-load spring 9 is fixed onto one end portion of the guide rail 8. The constant-load spring 9 is a kind of flat spring which is, for example, tightly coiled in a spiral manner. The constant-load spring 9 is enclosed with a housing 12, and the touch roller 5 is fixed onto the top of the housing 12. It is to be noted that the constant-load spring refers to a spring having a function to keep a constant load on a constant basis.

As shown in FIG. 2C, the housing 12 is biased in direction away from the bottom surface of the guide rail 8 (upward direction) by elasticity of the constant-load spring 9. The housing 12, which has a leg portion 12a coming into contact with a narrow width portion 8a of the guide rail 8, is supported by the guide rail 8 in the state of slightly floating from the bottom surface of the guide rail 8. The touch roller 5 is slidably supported by the guide rail 8 through the housing 12.

When force in arrow A direction shown in FIG. 2A acts upon the touch roller 5, the constant-load spring 9 expands and the touch roller 5 slides on the guide rail 8 as shown in FIG. 2B. Thus, the position of the touch roller 5 is adjusted in conformity to changes in diameter of the tape roll 11.

Thus, the tape cartridge in the present embodiment has the touch roller 5 (pressing member) for pressing an unwound portion of the tape 3 to the tape roll 11 at the contact start point P, and has the position adjustment member 6 for adjusting the position of the touch roller 5 in conformity to changes in diameter of the tape roll 11. Consequently, at the moment when the tape 3a (unwound portion) is wound onto the tape roll, the tape 3a is pressed to the side of the tape roll 11 by the touch roller 5 so that entrained air during winding of the tape can be released. Moreover, vibration and flipping of the tape can be suppressed. As a result, in the present invention, adverse influences on windability attributed to at least one cause selected from entrapment of entrained air, vibration of the tape 3a (unwound portion) and flipping of the tape 3a (unwound portion) are suppressed (see FIG. 1).

Further, in the example shown in FIG. 1, the guide roller 4 is provided, so that when the tape 3a goes into the case 1 away from the original running position, the guide roller 4 can return the running position of the tap to a normal position. Consequently, adverse influences on windability attributed to, for example, accuracy of the running system of the drive unit are suppressed, leading to further improvement in windability of the tape.

In the example shown in FIG. 1, the touch roller 5 is in a cylindrical shape. A longitudinal length L of the touch roller 5 (see FIG. 2A) should preferably be larger than the width of the tape 3. When the longitudinal length L of the touch roller 5 is larger than the width of the tape 3, the tape 3a can be evenly pressed along the entire width by the touch roller 5, resulting in further enhancement in the windability.

Although the reel 2 does not have a flange in the example described with reference to FIG. 1 and FIG. 2, the reel 2 may have a flange on the opposite side of the guide rail 8 of a roll core (cylindrical portion). In the case where the reel 2 had a flange, poor windability of tapes brought the flange into contact with the edge of the tapes, thereby causing the edge of the tapes to be damaged. Moreover, the flange were sometimes deformed due to fall during transportation, and in such cases, if the edge of the tapes was partially protruded due to poor windability of the tapes, then the protruded portions were sometimes folded. The tape cartridge in the present embodiment is sufficient in windability, which alleviates the damaged tape edge problem as well as the folded tape problem.

### Second Embodiment

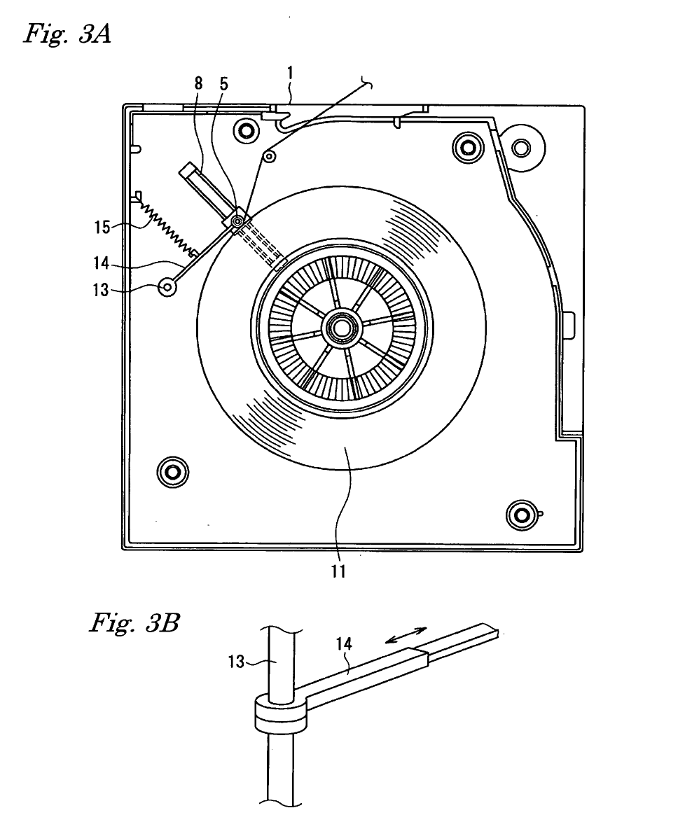

FIG. 3A shows a tape cartridge in another example of the present invention. The tape cartridge shown in FIG. 3A is identical in structure to that of the example shown in FIG. 1 except the position adjustment member, and therefore has identical effects.

In the tape cartridge shown in FIG. 3A, the position adjustment member includes a shaft pin 13 fixed onto the case 1, a rotation rod 14 fixed onto the shaft pin 13, and a coil spring 15 with one end being fixed onto the case 1 and the other end portion being fixed onto the rotation rod 14. As shown in FIG. 3B, the rotation rod 14 is secured rotatably around the axis of the shaft pin 13, and is capable of swinging in direction almost parallel to the principal surface of the case with the shaft pin 13 as a supporting point. Moreover the rotation rod 14 is composed of a plurality of rods with different diameters and a plurality of the rods are linked to each other in a telescopic manner. Therefore, the rotation rod 14 is expandable and contractable so that the touch roller 5 can slide on the guide rail 8 in conformity to changes in diameter of the tape roll 11.

### Third Embodiment

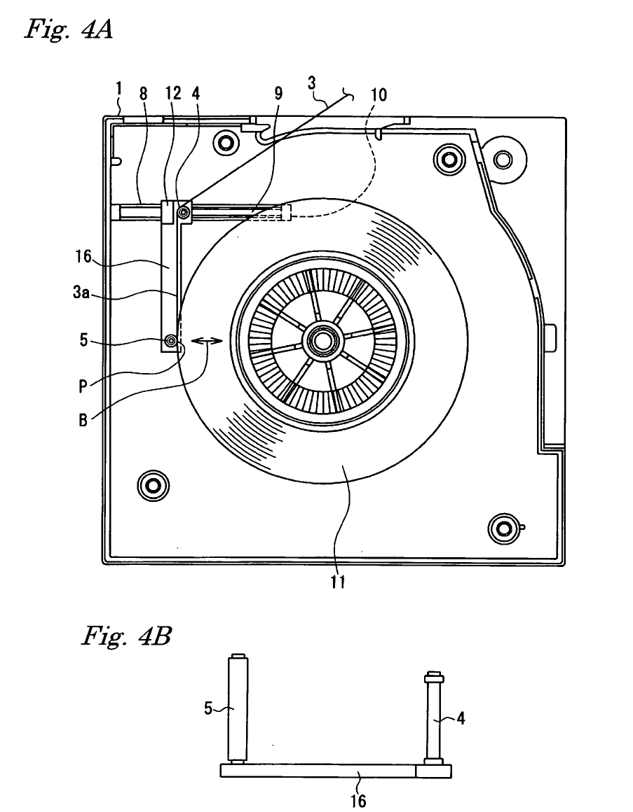

As shown in FIG. 4A, the tape cartridge in the present embodiment is identical in structure to the tape cartridge in the first embodiment except that the position adjustment member further has a plate 16, and that the guide roller 4 and the touch roller 5 are fixed onto one principal surface of the plate 16 and supported by the guide rail 8 through the plate 16, and therefore the tape cartridge in the present embodiment has identical effects to those of the first embodiment. FIG. 4B is a side view showing a structure composed of the guide roller 4, the touch roller 5 and the plate 16. In FIG. 4A, reference numeral 10 denotes a spring stopper and reference numeral 12 denotes a housing. A part of the constant-load spring 9 is housed in the housing 12.

As shown in FIG. 4A, in the tape cartridge in the present embodiment, the guide roller 4 and the touch roller 5 (pressing member) are fixed together onto the plate 16, which makes it possible to keep an angle between a tangent line across the contact start point P and a running direction of the tape 3a running between the guide roller 4 and the touch roller 5 constant during winding operation. Consequently, it becomes easy to make pressing force of the touch roller 5 onto the tape 3a constant during winding operation, resulting in further enhancement in windability.

It is to be noted that the pressure applied to the touch roller 5 along with changes in diameter of the tape roll 11 is transmitted to the constant-load spring 9 through the plate 16, which makes it possible to change the position of the touch roller 5, which is positioned on the plate 16, to those in longitudinal direction of the guide rail 8 along with changes in diameter of the tape roll 11.

As shown in FIG. 4A, it is preferable that the touch roller 5 and the guide roller 4 are disposed on one principal surface of the plate 16 in such a way that the tape 3a running between the guide roller 4 and the touch roller 5 is orthogonal to a radial direction B of the tape roll 11 across the contact start point P. More particularly, it is preferable that the touch roller 5 and the guide roller 4 are fixed onto the plate 16 in such a way that the tape 3a running between the guide roller 4 and the touch roller 5 travels on a tangent line across the contact start point P. Further, it is preferable that the longitudinal direction of the guide rail 8 is equal to the radial direction B of the tape roll 11 across the contact start point P. A contact area between the reel 5 and the tape 3 can be minimized when the running direction of the tape 3a running between the guide roller 4 and the touch roller 5 is aligned with the tangent line direction across the contact start point P, and the longitudinal direction of the guide rail 8 is equal to the radial direction of the tape roll 11 across the contact start point P.

It is to be noted that the term “orthogonal” is herein used not to strictly signify 90 degrees but to signify substantially orthogonal states such as being orthogonal in manufacturing tolerance ranges.

The terms “the running direction of the tape 3a running between the guide roller 4 and the touch roller 5 is aligned with the tangent line direction across the contact start point P” signify that when the tape cartridge in the present embodiment is two-dimensionally viewed from direction orthogonal to the principal surface of the case 1, the tape 3a running between the guide roller 4 and the touch roller 5 is overlapped with the tangent line across the contact start point P. Herein, the term “overlapped” is used not to strictly signify the state of being overlapped but to signify substantially overlapped states such as being overlapped in manufacturing tolerance ranges.

Moreover, the terms “the longitudinal direction of the guide rail 8 is equal to the radial direction B of the tape roll 11 across the contact start point P” include the following both cases (1) the longitudinal direction of the guide rail 8 is overlapped with the radial direction B of the tape roll 11 across the contact start point P and (2) the longitudinal direction of the guide rail 8 is parallel to the radial direction B of the tape roll 11 across the contact start point P, when the tape cartridge in the present embodiment is two-dimensionally viewed from the direction orthogonal to the principal surface of the case 1. Herein, the term “parallel” is used not to strictly signify the state of being parallel but to signify substantially parallel states such as being parallel in manufacturing tolerance ranges.

If an angle between the running direction of the tape 3a running between the guide roller 4 and the touch roller 5 and the tangent line direction across the contact start point P is relatively large, then a contact area between the touch roller 5 and the tape 3a is enlarged. Consequently, adverse influences exerted on windability by the shape and the like of the touch roller 5 are increased. Minimizing the contact area between the touch roller 5 and the tape 3a as in the example shown in FIG. 4A makes it possible to suppress the adverse influences on windability attributed to the shape and the like of the touch roller 5.

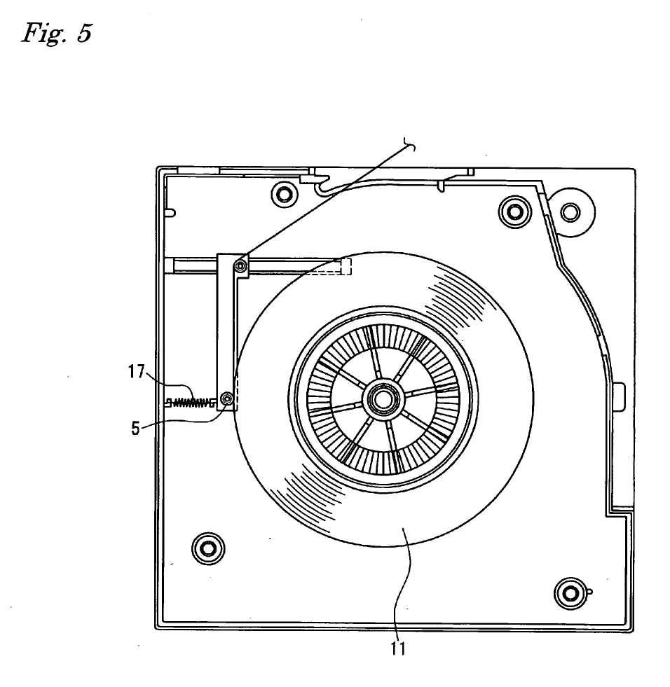

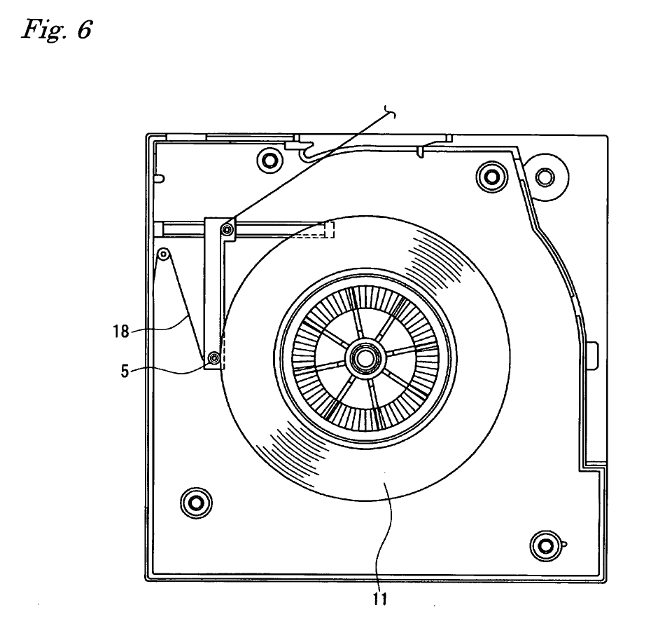

Although the constant-load spring 9 is used as a spring-type elastic body in the example described with reference to FIGS. 4A to 4B, the constant-load spring 9 may be replaced with a coil spring 17 or a torsion spring 18 as shown in FIG. 5 and FIG. 6.

The spring constant of the coil spring 17 and the torsion spring 18 should preferably be not more than 0.5N/mm. If the spring constant of the coil spring 17 and the torsion spring 18 is not more than 0.5N/mm, a load applied to the tape by the touch roller 5 may easily be kept constant even with changes in diameter of the tape roll 11 as with the case of using the constant-load spring 9, and this allows stable release of entrained air. Moreover, vibration and flipping of the tape may stably be suppressed. It is to be noted that the lower limit of the spring constant is not particularly stipulated, though it is normally preferable that the spring constant is not less than 0.01N/mm.

### Fourth Embodiment

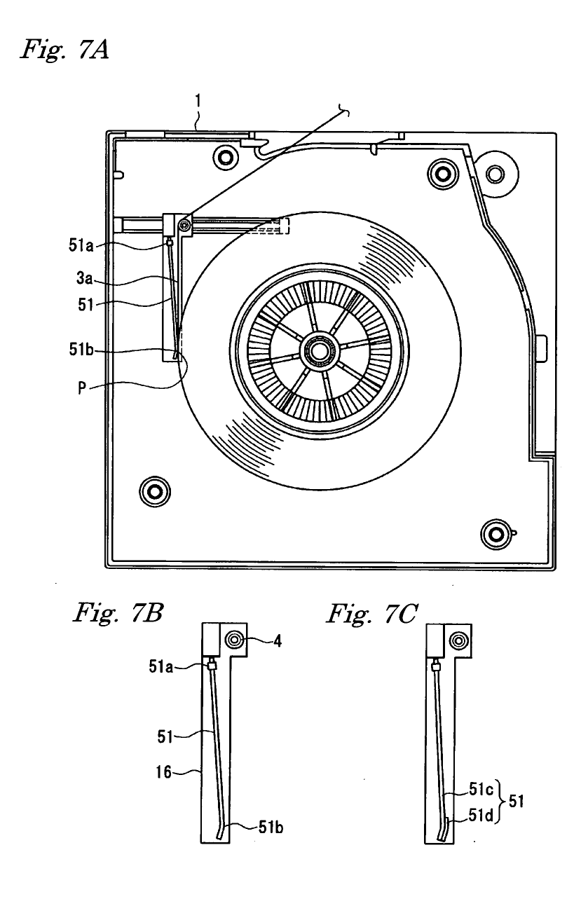

As shown in FIG. 7A, a tape cartridge in the present embodiment is identical in structure to the tape cartridge in the third embodiment except that the touch roller 5 (see FIG. 4) is replaced with a sheet-like member 51 serving as a pressing member, and therefore has identical effects to those of the third embodiment. FIG. 7B is an enlarged plane view showing a structure composed of a guide roller 4, the sheet-like member 51 and a plate 16.

One end portion of the sheet-like member 51 is fixed onto the plate 16 by a fixing member 51a. The sheet-like member 51 has a function identical to that of the touch roller 5 (see FIG. 4). The sheet-like member 51 is more preferable than the touch roller because the sheet-like member 51 is smaller in thickness (maximum width) as viewed from the direction orthogonal to the principal surface of the case 1 than the touch roller 5 (see FIG. 4) and therefore can be disposed in smaller space.

The material of the sheet-like member 51, which is not particularly limited, includes, for example, polyethlene terephthalates, polytetrafluoroethylenes (PTFEs), and polyethylenes. The thickness of the sheet-like member 51 is not particularly limit, though the appropriate thickness is generally 0.05 mm to 1 mm. The sheet-like member 51 should preferably be curved at a position corresponding to the contact start point P. This decreases a contact area between the sheet-like member 51 and the tape 3a, and makes it possible to suppress unnecessary friction between the sheet-like member 51 and the tape 3a.

As shown in FIG. 7B, a surface 51b of the sheet-like member 51 which comes into contact with the tape should preferably contain at least one kind of low-friction materials selected from a group composed of fluorine resins, silicon resins and ultrahigh molecular weight polyethylenes. This is because if the surface 51b of the sheet-like member 51 which comes into contact with the tape contains the low-friction materials, it becomes possible to suppress deterioration of the tape due to friction. As shown in FIG. 7C, the sheet-like member 51 may be composed of a base member 51c made of polyethlene terephthalates, polyethylenes (PEs) or the like, and a low-friction member 51d made of the low-friction materials, or the entire sheet-like member 51 may be formed from the low-friction materials. The fluorine resins include, for example, PTFEs, tetrafluoroethylene perfluoroalkylvinylether copolymers (PFAs), polychloro-trifluoroethylenes (PCTFEs) and Polyvinylidene fluoroethylenes (PVDFs). Commercially available fluorine resins include, for example, Teflon (trade mark). The ultrahigh molecular weight polyethylenes should preferably have a molecular weight of 1,000,000 to 5,000,000.

Moreover, the surface 51b of the sheet-like member 51 which comes into contact with the tape should preferably be uneven like dimpled surfaces. If the surface 51b of the sheet-like member 51 which comes into contact with the tape is uneven, a contact area with the tape is decreased, and this makes it possible to suppress deterioration of the tape by friction.

### Fifth Embodiment

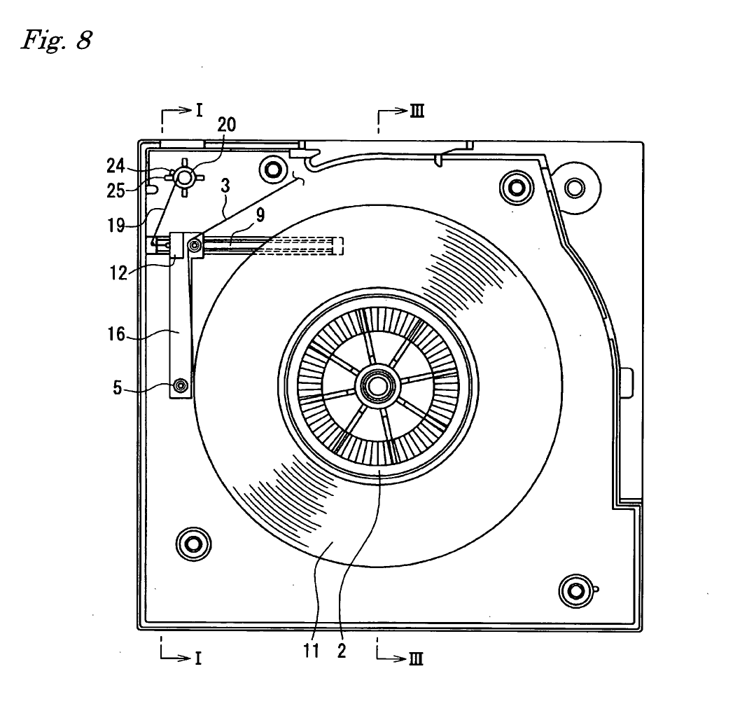

As shown in FIG. 8 to FIG. 10, a tape cartridge in the present embodiment is identical in structure to the tape cartridge in the third embodiment except that a pressing cancellation mechanism for canceling the touch roller 5 (pressing member) pressing the tape roll 11 is further provided, and therefore the tape cartridge in the present embodiment has identical effects to those of the third embodiment.

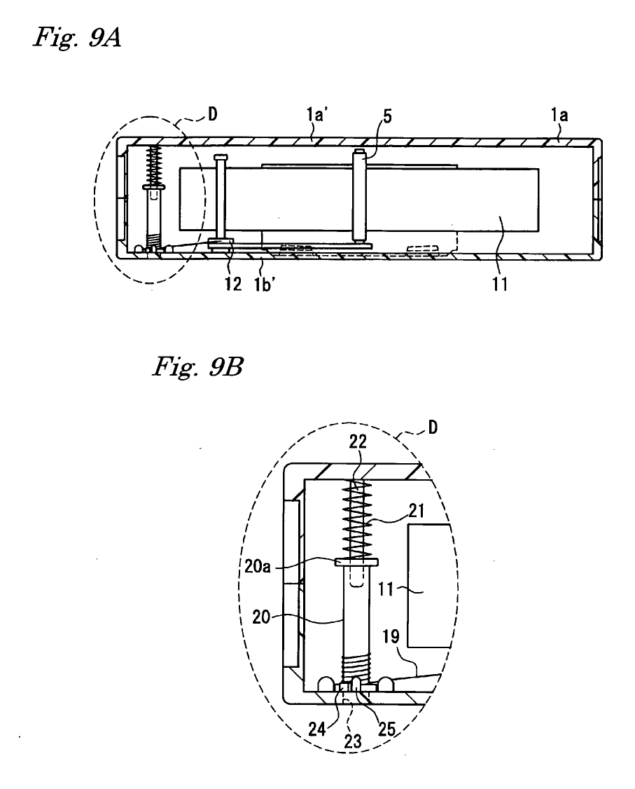

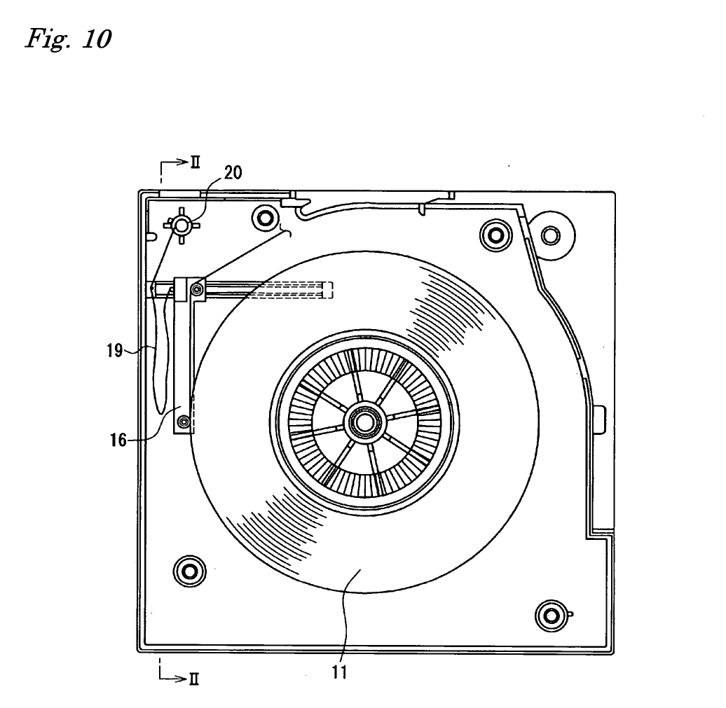

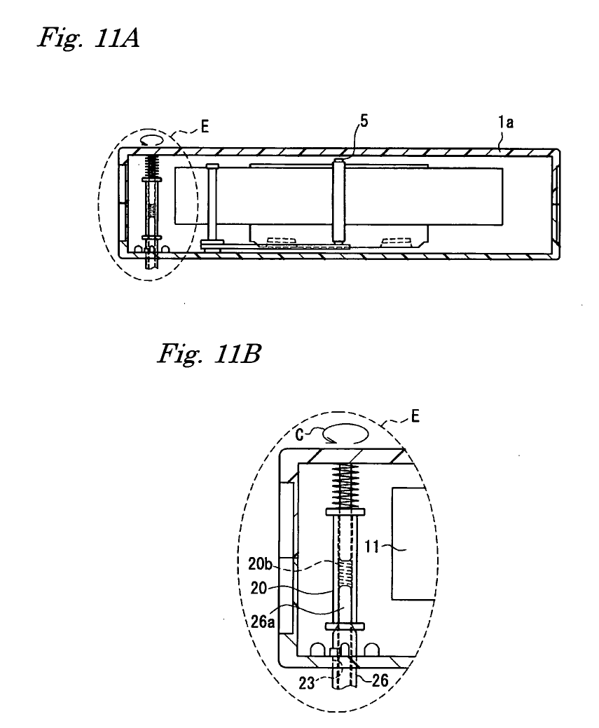

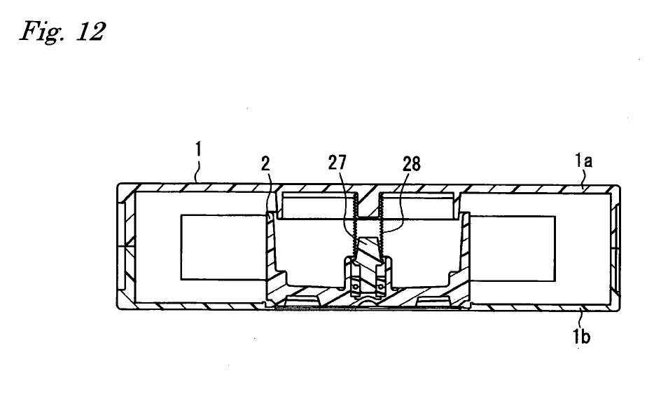

FIG. 8 is a schematic view showing an inner structure of the tape cartridge in the present embodiment in the state of being not loaded into a drive unit, FIG. 9A is a cross sectional view taken along line I-I in FIG. 8, and FIG. 9B is an enlarged view showing a section D in FIG. 9A. FIG. 8 shows the state that an upper cover 1a in FIG. 9A is removed. FIG. 10 is a schematic view showing an inner structure of the tape cartridge in the present embodiment immediately after being loaded into the drive unit, FIG. 11A is a cross sectional view taken along line II-II in FIG. 10, and FIG. 11B is an enlarged view showing a section E in FIG. 11A. FIG. 10 shows the state that an upper cover 1a in FIG. 11A is removed. FIG. 12 is a cross sectional view taken along line III-III in FIG. 8.

Normally, when the tape roll 11 and the touch roller 5 (pressing member) come into contact and the tape roll 11 (tape 3) is pressed by the touch roller 5, adverse influences may be exerted on the tape 3 during storage of the cartridge. When the tape 3 is not run, it is not necessary to press the tape roll 11 (tape 3) by the touch roller 5.

Moreover, in the state that the tape roll 11 is pressed by the touch roller 5, the position of the reel 2 is sometimes slightly displaced in pressing direction of the touch roller 5 compared to the position of the reel 2 in the state that the tape roll 11 is not pressed by the touch roller 5. Accordingly, when the tape cartridge in the present embodiment is loaded into drives unit for use in recording with use of conventional tape cartridges, a probability of engagement error during engagement between a reel drive gear provided on the reel 2 and a drive gear provided on the drive unit increases.

The tape cartridge in the present embodiment has a pressing cancellation mechanism shown below, which makes it possible to prevent the tape 3 from being deteriorated and to decrease the probability of engagement error.

As shown in FIG. 8 and FIG. 9, the pressing cancellation mechanism is composed of a wire 19 whose one end portion is connected to a housing 12, a cylinder 20 onto which the other end portion of the wire 19 is fixed and onto which the wire 19 can be reeled, a through hole 23 formed on the case, a spring member 21 and a lock mechanism. The lock mechanism has a protrusion 24 and a stopper 25.

In the example shown in FIG. 8 and FIG. 9, one end portion of the wire 19 is directly linked to the housing 12 housing the constant-load spring 9 (see FIG. 8) and is indirectly linked to the touch roller 5 (pressing member) through the housing 12, the plate 16 and the like. As long as one end portion of the wire 19 is indirectly or directly linked to the touch roller 5 (pressing member), the wire 19 may be linked not only to the housing 12 but also to any one of the guide roller 4, the touch roller 5 and the plate 16.

The cylinder 20 is rotatable in a specified direction around its central axis. Rotation of the cylinder 20 in a specified direction makes it possible to reel the wire 19 till the touch roller 5 is away from the tape roll 11 (see FIG. 8).

As shown in FIG. 11B, the cylinder 20 has a hollow portion (inner space) linked to the through hole 23 formed on the case, and a spiral groove is formed on an inner face 20b of the cylinder 20. Moreover, as shown in FIG. 9B, the cylinder 20 has a flange portion 20a on both end portions.

As shown in FIG. 9, the through hole 23 is formed in a position corresponding to the cylinder 20, the position on one wall 1b′ out of a pair of walls facing each other and constituting the case 1. A pair of the walls are orthogonal to the longitudinal direction of the cylinder 20. It is to be noted that the term “orthogonal” is herein used not to strictly signify 90 degrees but to signify substantially orthogonal states such as being orthogonal in manufacturing tolerance ranges. The diameter of the through hole 23 is larger than the inner diameter of the cylinder 20 to a certain degree.

The spring member 21 is disposed between the other wall 1a′ out of a pair of the walls (i.e., the wall without the through hole 23) and the cylinder 20 for biasing the cylinder 20 to the side of the wall having the through hole 23 (one wall 1b′).

In the tape cartridge in the present embodiment, the pressing cancellation mechanism further has a guide rod 22. One end of the guide rod 22 is fixed onto the other wall 1a′ of the case 1. The other end side of the guide rod 22 is inserted into the inner space (hollow portion) of the cylinder 20. Consequently, up-and-down motions of the cylinder 20 are performed along longitudinal direction of the guide rod 22. Moreover, since the guide rod 22 is also inserted into the spring member 21, expansion and contraction of the spring member 21 are also performed along longitudinal direction of the guide rod 22.

As shown in FIG. 8 and FIG. 9, the lock mechanism includes the protrusion 24 and the stopper 25 as described before. The lock mechanism prevents the cylinder 20 from rotating in an opposite direction of a specified direction (taking-up direction of the wire) in the state that the wire 19 is reeled onto the cylinder 20 and that the touch roller 5 is away from the tape roll 11.

The protrusion 24, which is formed on an end portion of the cylinder 20 on the side of the through hole 23, protrudes from the outer peripheral face of the cylinder 20. The stopper 25 is formed in such a position as to be able to engage with the protrusion 24 in the state that the cylinder 20 is pressed toward one wall (wall having the through hole 23) 1b′ of the case by the spring member 21. In the tape cartridge in the present embodiment, the stopper 25 is integrated with the wall of the case (one wall 1b′) having the through hole 23, and is disposed around the through hole 23. If the lock mechanism is activated in the state that the wire 19 is reeled onto the cylinder 20 till the touch roller 5 is away from the tape roll 11, then pressing of the tape roll 11 by the touch roller 5 can be cancelled. Therefore, in the tape cartridge in the present embodiment, it becomes possible to prevent deterioration of the tape attributed to the tape roll 11 being pressed by the touch roller 5 for a long period of time, and to decrease the probability of engagement error during engagement between the reel drive gear and the drive gear of the drive unit.

As shown in FIG. 10 and FIG. 11, once the tape cartridge in the present embodiment is loaded into the drive unit, a pin 26 is inserted into the through hole 23 in conjunction with the drive gear of the drive unit. The pin 26 is a component part of the drive unit. A spiral thread (unshown) is formed on a surface 26a of the pin 26. Since the spiral thread formed on the surface 26a of the pin 26 is formed corresponding to a spiral groove 20b formed on the inner face of the cylinder 20, the cylinder 20 rotates in direction of an arrow C shown in FIG. 11B when the pin 26 is inserted into the case 1 through the through hole 23. With rotation of the cylinder 20, the wire 19 reeled onto the cylinder 20 is loosened as shown in FIG. 10.

The shape of the spiral groove formed on the inner face of the cylinder 20 should appropriately be set so that the length of a portion of the wire 19 feedable from the cylinder 20 in the state of being unlocked by the lock mechanism is longer than a slide distance of the plate 16 which moves with changes in diameter of the tape roll 11.

The spiral groove 20b formed on the inner face of the cylinder 20 (see FIG. 11B) may be a spiral thread, while the spiral thread formed on the surface 26a of the pin 26 may be a spiral groove.

It is to be noted that as shown in FIG. 12, the case 1 is formed by combination of an upper cover 1a and a lower cover 1b. Inside the case 1, the reel 2 is pressed downward as viewed in the drawing by a helical compression spring 28 acting upon the reel through a shaft 27. By this, the reel 2 is prevented from idling in an unused condition.

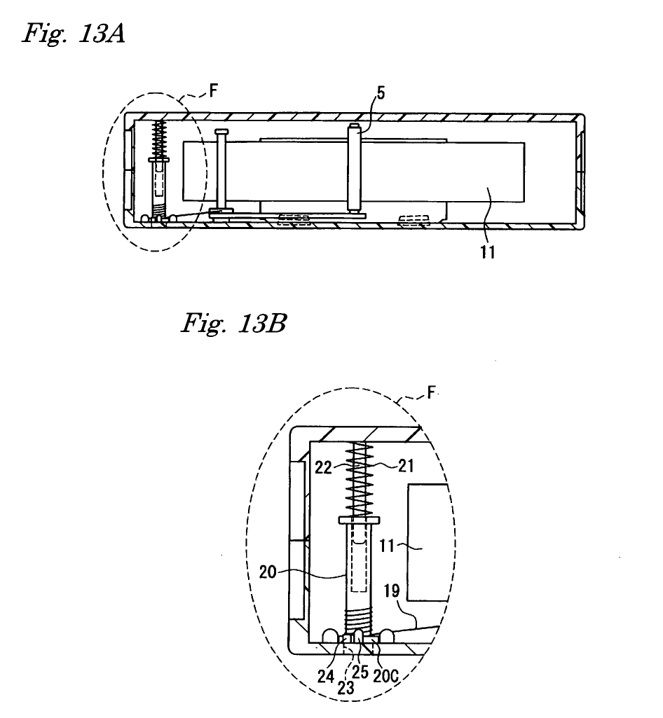

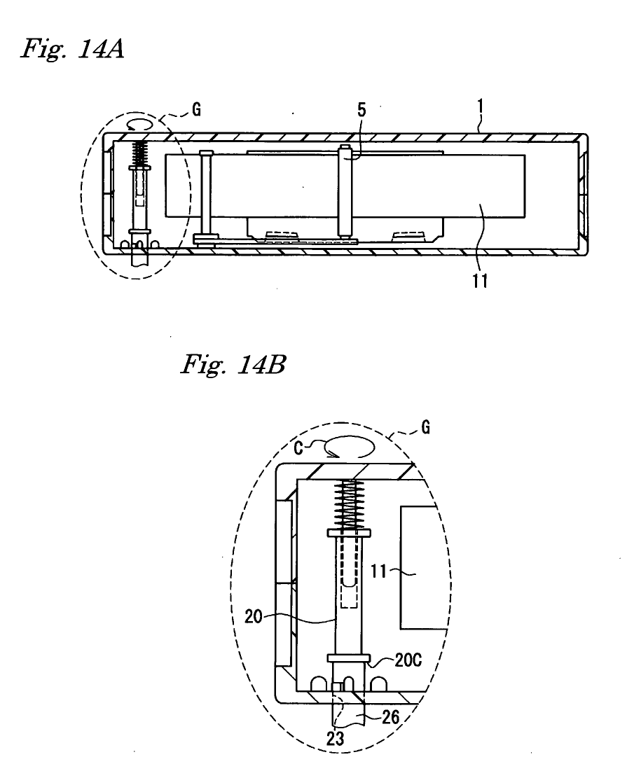

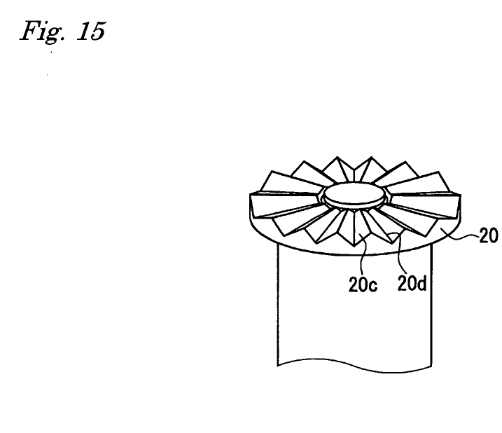

Description is now given of a pressing cancellation mechanism in another example with reference to FIG. 13 to FIG. 15. FIG. 13A is a cross sectional view showing a tape cartridge in the present embodiment in the state of being not loaded into the drive unit, FIG. 13B is an enlarged view showing a section F in FIG. 13A. FIG. 14A is a cross sectional view showing the tape cartridge in the present embodiment immediately after being loaded into the drive unit. FIG. 14B is an enlarged view showing a section G shown in FIG. 14A. FIG. 15 is a fragmentary enlarged perspective view showing a cylinder 20 constituting the tape cartridge in the present embodiment shown in FIG. 13 and FIG. 14. In FIG. 13B, there are shown a guide rod 22, a spring member 21, a protrusion 24, and a stopper 25. The protrusion 24 and the stopper 25 constitute a lock mechanism.

As shown in FIG. 15, a face (bottom face) 20c of a cylinder 20 facing a through hole 23 (see FIG. 13B) includes an uneven face as a plurality recess portions 20d are formed radially thereon. On a face of a pin 26 facing the bottom face 20c of the cylinder 20, protruding portions (unshown) corresponding to the recess portions 20d are radially formed. Consequently, when the pin 26 is inserted into the case 1 through the through hole 23 as shown in FIG. 14B, and the pin 26 is pushed into the case 1 while being rotated in an arrow C direction after the recess portions formed on the bottom face 20c are aligned with the protruding portions formed on the pin 26, a wire 19 (see FIG. 13B) reeled onto the cylinder 20 can be loosened.

If the pin 26 is pulled out of the case 1 while being rotated in an opposite direction of the arrow C (wire taking-up direction), the wire 19 is reeled onto the cylinder 20 till the touch roller 5 is away from the tape roll 11 (see FIG. 13B). If the lock mechanism is activated, then cancellation of the touch roller 5 pressing the tape roll 11 can be maintained. It is to be noted that the lock mechanism in the pressing cancellation mechanism described with reference to FIG. 13 to FIG. 15 is identical to that in the pressing cancellation mechanism described with reference to FIG. 8 to FIG. 11.

The radial recess portions 20d formed on the bottom face 20c of the cylinder 20 (see FIG. 15) may be radial protruding portions, while the radial protruding portions formed on the pin 26 may be radial recess portions. Moreover, although the recess portions formed on the bottom face of the cylinder 20 and the protruding portions formed on the pin 26 are both in a radial shape in the example described with reference to FIG. 13 to FIG. 15, the bottom face of the cylinder 20 may contain any uneven face as long as the bottom face of the cylinder 20 can engage with the face of the pin facing this bottom face.

Although one end of the wire 19 is indirectly linked to the touch roller 5 (pressing member) through the housing 12, the plate 16 and the like in the example shown in FIG. 8 to FIG. 14, the present invention is not limited thereto. One end of the wire 19 may directly be fixed onto the touch roller 5. Moreover, in the present embodiment, the pressing member may be a sheet-like member 51 (see FIG. 7).

The tape cartridge in the present invention is excellent in windability and therefore is useful as a tape cartridge.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A tape cartridge, comprising:
a case;
a reel disposed inside the case;
a band-like tape which can be wound onto the reel in a feedable way;
a pressing member disposed inside the case for pressing an unwound portion of the tape to a tape roll at a contact start point between the unwound portion and the tape roll during winding of the tape, the tape roll being composed of a wound portion of the tape which is wound onto the reel and the reel; and
a position adjustment member for adjusting a position of the pressing member in conformity to changes in diameter of the tape roll while supporting the pressing member.

2. The tape cartridge as defined in claim 1, wherein the pressing member is a touch roller.

3. The tape cartridge as defined in claim 2, wherein a length of the touch roller in longitudinal direction is larger than a width of the tape.

4. The tape cartridge as defined in claim 1, wherein the pressing member is a sheet-like member.

5. The tape cartridge as defined in claim 4, wherein a face of the sheet-like member which comes into contact with the tape contains at least one kind of low-friction materials selected from a group composed of fluorine resins, silicon resins and ultrahigh molecular weight polyethylenes.

6. The tape cartridge as defined in claim 4, wherein the face of the sheet-like member which comes into contact with the tape is uneven.

7. The tape cartridge as defined in claim 1, wherein the position adjustment member comprises a spring-type elastic body for biasing the pressing member to a side of the tape roll, and a guide rail supported by the case for allowing the pressing member to slide.

8. The tape cartridge as defined in claim 1, further comprising:
an aperture formed on the case for pulling the tape out of the case; and
a guide roller disposed closer to the aperture than the pressing member for regulating a running position of the tape.

9. The tape cartridge as defined in claim 7, further comprising:
an aperture formed on the case for pulling the tape but of the case; and
a guide roller disposed closer to the aperture than the pressing member for regulating a running position of the tape, wherein
the position adjustment member further comprises a plate, and
the guide roller and the pressing member are fixed onto one principal surface of the plate, and the guide roller and the pressing member are supported by the guide rail through the plate.

10. The tape cartridge as defined in claim 9, wherein the spring-type elastic body includes coil springs, torsion springs and constant-load springs.

11. The tape cartridge as defined in claim 10, wherein a spring constant of the coil spring or the torsion spring is not more than 0.5N/mm.

12. The tape cartridge as defined in claim 9, wherein the pressing member and the guide roller are disposed in such a way that a running direction of the tape running between the guide roller and the pressing member is orthogonal to a radial direction of the tape roll across the contact start point P, and
a longitudinal direction of the guide rail is identical to the radial direction of the tape roll.

13. The tape cartridge as defined in claim 12, further comprising a pressing cancellation mechanism for canceling the pressing member pressing the tape roll, wherein
the pressing cancellation mechanism comprises:
a wire whose one end portion is indirectly or directly linked to the pressing member;
a cylinder onto which the other end portion of the wire is fixed and onto which the wire can be reeled till the pressing member is away from the tape roll by the cylinder rotating in a specified direction around its central axis,
a through hole formed in a position corresponding to the cylinder, the position on one wall out of a pair of walls of the case which are orthogonal to longitudinal direction of the cylinder;
a spring member for biasing the cylinder to a side of the through hole; and
a lock mechanism for preventing the cylinder from rotating in an opposite direction of the specified direction in a state that the wire is reeled onto the cylinder till the pressing member is away from the tape roll,
a spiral groove or a spiral thread is formed on an inner face of the cylinder, and
the lock mechanism comprises: a protrusion formed in an end portion of the cylinder on a side of the through hole; and a stopper formed on the one wall of the case so as to be able to engage with the protrusion in a state that the cylinder is pressed to the one wall by the spring member.

14. The tape cartridge as defined in claim 12, further comprising a pressing cancellation mechanism for canceling the pressing member pressing the tape roll, wherein,
the pressing cancellation mechanism comprises:
a wire whose one end portion is indirectly or directly linked to the pressing member;
a cylinder onto which the other end portion of the wire is fixed and onto which the wire can be reeled till the pressing member is away from the tape roll by the cylinder rotating in a specified direction around its central axis,
a through hole formed in a position corresponding to the cylinder, the position on one wall out of a pair of walls of the case which are orthogonal to longitudinal direction of the cylinder;
a spring member for biasing the cylinder to a side of the through hole; and
a lock mechanism for preventing the cylinder from rotating in an opposite direction of the specified direction in a state that the wire is reeled onto the cylinder till the pressing member is away from the tape roll,
a face of the cylinder facing the through hole contains a protruding portion or a recess portion, and
the lock mechanism comprises: a protrusion formed in an end portion of the cylinder on a side of the through hole; and a stopper formed on the one wall of the case so as to be able to engage with the protrusion in a state that the cylinder is pressed to the one wall by the spring member.

15. The tape cartridge as defined in claim 13, therein
the pressing cancellation mechanism further comprises a guide rod, and
one end of the guide rode is fixed onto the other wall out of a pair of walls of the case, while the other end side of the guide rod is inserted into an inner space of the cylinder.
